(19) United States
(12) Patent Application Publication
(10) Pub. No.: US 2026/0342627 A1
(43) Pub. Date: Oct. 29, 2026

(54) Modulator and apparatus with Bluetooth modulator

(71) Applicant: Cypress Semiconductor Corporation, San Jose, CA (US)

(72) Inventor: Giuseppe LI PUMA, Bochum (DE)

(73) Assignee: Cypress Semiconductor Corporation, San Jose, CA (US)

(21) Appl. No.: 19/187,761

(22) Filed: Apr. 23, 2025

(51) Int. Cl. H04L 27/12; H04W 4/80

(52) U.S. Cl. CPC H04L 27/127; H04W 4/80

(57) ABSTRACT

Various modulators are provided that allow adding noise via a noise generator to a modulation path of the modulator thereby adjusting the SNR of the output signal. The approach can be used for Bluetooth channel sounding.

### TECHNICAL FIELD

This disclosure generally relates to technologies for positioning and ranging using wireless signals.

### BACKGROUND

As is described in [P. Zand, J. Romme, J. Govers, F. Pasveer and G. Dolmans, “A high-accuracy phase-based ranging solution with Bluetooth Low Energy (BLE),” 2019 IEEE Wireless Communications and Networking Conference (WCNC), 2019, pp. 1-8, doi: 10.1109/WCNC.2019.8885791], Multi-Carrier Phase Difference (MCPD) is a transmitter-to-transmitter based ranging solution used in different technologies. In the Bluetooth standard, MCPD is engaged for High-Accuracy Distance Measurement (HADM), also denoted as Channel Sounding (CS), to localize the position of a Bluetooth device. MCPD utilizes a series of phase measurements across multiple frequency channels.

According to the Bluetooth Special Interest Group, a control of the transmit signal-to-noise ratio (SNR-TX) is requested for the purpose of channel sounding (BT-CS, Bluetooth channel sounding), see Vol. 6 Bluetooth Low Energy Controller of the BT Core 6.0 Specification, in particular page 2892 et seqq., chapter 3.1.3 “SNR control for Channel Sounding steps”. A device complying with the Bluetooth regulation needs to be capable of adjusting its SNR output within a given range for modulated transmissions.

It is an objective to provide an improved approach to adjust the SNR of a transmitter, in particular a Bluetooth transmitter.

### BRIEF DESCRIPTION OF THE DRAWINGS

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a schematic block diagram of an IQ-transmitter for BT-CS operating as an intermediate frequency up-conversion transmitter.

FIG. 2 shows a schematic block diagram of a hybrid transmitter with a noise generator.

FIG. 3 shows a diagram visualizing a curve of coefficients of a GFSK filter and a curve of coefficients of a (e.g., pre-defined) FIR filter.

FIG. 4 shows a schematic block diagram of a digital PLL with a two-point modulation, which can be used in frequency modulation systems, wherein the modulation signal is applied via two different paths.

FIG. 5 shows a schematic block diagram of a polar modulation approach.

FIG. 6 shows a direct FM modulation approach.

FIG. 7 shows an example block diagram visualizing different use cases for a system implementation.

FIG. 8 shows a block diagram of a system useable for range measurement.

### DETAILED DESCRIPTION

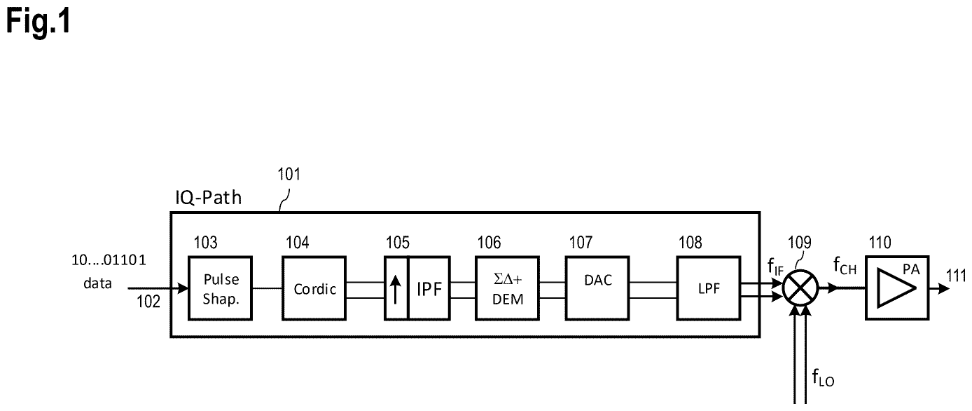

FIG. 1 shows a schematic block diagram of an IQ-transmitter for BT-CS operating as an intermediate frequency up-conversion transmitter.

The IQ-transmitter comprises an IQ-path 101 to which data (e.g., as a binary signal) 102 is input. The IQ-path 101 comprises a pulse shaper 103, a Cordic unit 104, a block 105, a sigma-delta modulator 106, a digital-to-analog converter (DAC) 107 and a low-pass filter (LPF) 108.

The block 105 comprises an upsampler (indicated by an arrow) and an interpolation filter IPF.

Hence, FIG. 1 visualizes a signal processing chain of the IQ-transmitter for Gaussian frequency shift keying (GFSK) modulation.

The (binary) data 102 is denoted as b[n], where b[n] ∈ {0,1}, representing digital information to be transmitted. The binary data b[n] is converted to a bipolar sequence d[n] with d[n] ∈ {−1,1}. The conversion can be mathematically described as

d[n]=2·b[n]−1.

The bipolar sequence d[n] is fed into the pulse shaping filter 103. For GFSK modulation, a Gaussian filter is typically used to smoothen the transitions between bits and to control the bandwidth of the signal. The output of the pulse shaping filter 103 is determined as

$$u [ n ] = {\sum }_{n = 0} d [ n ] \cdot h [ t - nT ] ,$$

where h(t) is a pulse shaping filter response and T a symbol period.

The output of the pulse shaping filter u(t) is applied to the Cordic unit 104 which generates an in-phase (I) component and a quadrature (Q) component as follows: The phase modulated signal can be expressed as

φ(t)=2πf_{IF}t+k_{F}∫u(τ)dτ=2πf_{IF}t+θ(t),

with

θ(t)=k_{F∫}u(τ)dτ.

f_{IF} is the intermediate frequency, and k_{F} is a frequency sensitivity factor. The Cordic algorithm then generates the I and Q signals:

I_{IF}(t)=A cos(φ(t))

and

Q_{IF}(t)=A sin(φ(t)) is

which can be written as

I_{IF}(t)+jQ_{IF}(t)=e^{+2πf}^{_{IF}}^{t} (I_{BB}(t)+jQ_{BB}(t))

with

I_{BB}(t)=A cos (θ(t))

and

Q_{BB}(t)=A sin(θ(t)).

In the block 105, the I and Q signals are then up-sampled to a higher rate suitable for subsequent processing. The interpolation filter IPF is used to attenuate spectral images and smoothen the waveform.

The up-sampled and interpolated I and Q signals are further processed by the sigma-delta modulator 106. The sigma-delta modulator operates at a high sampling rate and shapes the quantization noise to higher frequencies, which can be filtered out by the subsequent low-pass filter 108. Optionally, the sigma-delta modulator 106 may comprise a Dynamic Element Matching (DEM) circuit to minimize mismatches in the digital-to-analog conversion process.

The output of the sigma-delta modulator 106 are processed by the DAC 107 and the analog signals provided by the DAC 107 are further processed by the LPF 108 removing high-frequency components and smoothened signals. The analog signals at the output of the LPF 108 can be summarized as

I_{LPF}⁽t)=I_{DAC}(t)*h_{LPF}(t),

Q_{LPF(}t)=Q_{DAC}(t)*h_{LPF}(t),

where h_{LPF}(t) is the impulse response of the LPF and * denotes the convolutional operator.

Finally, the filtered I and Q signals are mixed with local oscillator (LO) signals to generate the carrier signal at the center frequency f_{CH}. The LO signals can be approximated as follows:

LO₁(t)=cos (2πf_{LO}t),

LO_{Q}(t)=sin (2πf_{LO}t).

Hence, the upconverted signal amounts to

s(t)=I_{LPF}(t) LO_{I}(t)—Q_{LPF}(t)LO_{Q}(t)

which can be rewritten as

s(t)=I_{LPF}(t) cos(2πf_{LO}^{t})—Q_{LPF}(t) sin(2πf_{LO}t)

or

s(t)=I_{BB}(t) cos(2π(f_{LO+}f_{IF})t)—Q_{BB}(t) sin(2π(f_{LO+}f_{IF})t).

The IQ-path 101 splits the binary signal 102 into an I-portion and a Q-portion at an intermediate frequency f_{IF} that are mixed with a local oscillator signal f_{LO} at an up-converter 109 into the signal s(t) which is fed to a power amplifier 110. The output of the power amplifier (PA) 110 supplies an output signal 111.

It is noted that s(t) is regarded as the output of the up-converter 109 and it is a signal around the signal f_{CH}, which serves as the center frequency of s(t).

The control of the output SNR can be achieved by changing the noise of the analog circuit blocks, e.g., changing bias currents in the LPF 108. However, changing the noise of the analog circuit blocks can add imprecisions that result in output signals 111 that no longer comply with Bluetooth regulations.

Example embodiments suggest an improved and precise control of the SNR of the transmitter.

### Example: Noise Supplied to PLL, Hybrid Transmitter

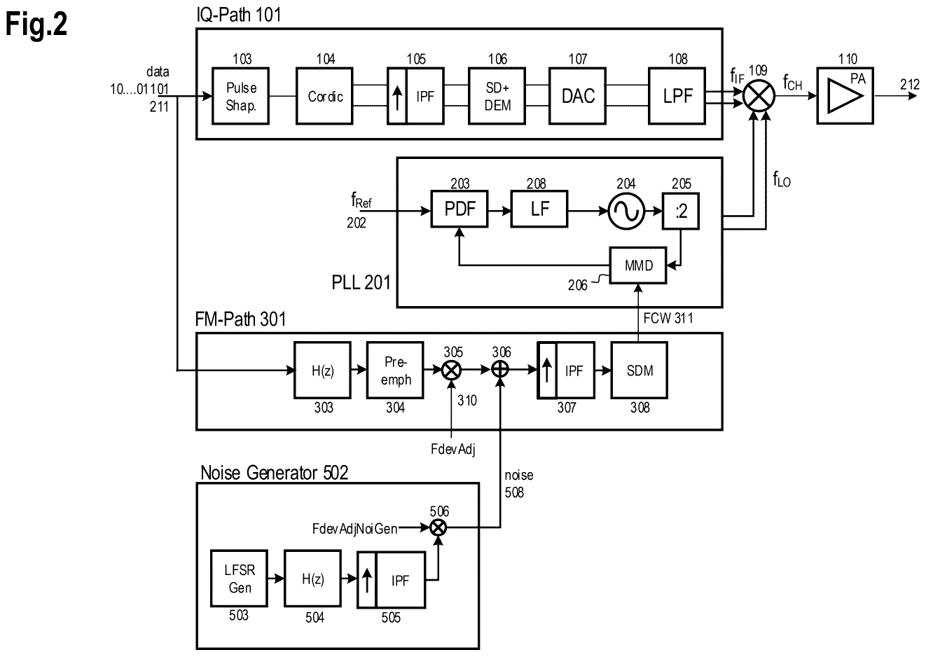

FIG. 2 shows a schematic block diagram of a hybrid transmitter comprising the IQ path 101 shown in FIG. 1, a phase-locked loop (PLL) 201 that supplies the local oscillator signal f_{L0} to the combiner 109, a frequency modulated (FM) path 301 and a noise generator (NG) 502. It is noted that the NG 502 may add noise to the phase and/or the frequency of a signal.

Data 211 are provided to the IQ path 101 as well as the FM path 301 and an output signal 212 is supplied by the PA 110.

The PLL 201 comprises a phase frequency detector (PFD) 203 and a loop filter (LF) 208, a voltage controlled oscillator (VCO) 204 and a divider 205 as well as a multi-modulus divider (MMD) (also referred to as feedback divider) 206.

A reference signal f_{Ref} 202 is input to the PLL 201 and processed by the PFD 203, the LF 208, the VCO 204, the divider 205 and the MMD 206 into the local oscillator signal f_{LO}. The MMD 206 receives a frequency control word (FCW) 311 from the FM path 301 to adjust the SNR of the output signal 212.

The FM path 301 comprises a filter 303, a pre-emphasis filter 304, a multiplier 305, an adder 306, a block 307 comprising an upconverter (indicated by an arrow) with an interpolation filter IPF and a sigma-delta modulator (SDM) 308. The data 211 are fed via the filter 303 and the pre-emphasis filter 304 to the multiplier 305 where the signal is weighted by a gain 310 (referred to as FdevA dj) that is used to adjust the frequency deviation of the signal. The output of the multiplier 305 is connected to a first input of the adder 306 and a second input of the adder 306 obtains noise 508 from the NG 502. The output of the adder 306 is connected to the block 307 and the output of the block 307 is connected to the SDM 308. The SDM 308 supplies the FCW 311 to the MMD 206 of the PLL 201.

The noise 508 can be provided by noise generators of different implementations. The example noise generator 502 shown in FIG. 2 is based on an LFSR generator and will be explained in more detail below.

The noise 508 provided by the noise generator 502 is added to the FM path which leads to a broadening of the respective constellation points along the circle of the constellation diagram, i.e., the range of the appearance of the constellation points is widened.

The hybrid transmitter of FIG. 2 comprises a two-point modulation method: For generating the BT-CS packet the transmitter operates as an IQ-transmitter. For controlling the SNR of the transmitter, the local oscillator signal f_{LO} is generated by the PLL 201 as a direct modulator injecting a noise sequence as modulation signal to the MMD 206 of the PLL 201.

### Example: Noise Generator Comprising LFSR Generator

An example implementation of the noise generator 502 comprises a generator based on linear feedback shift registers (LFSR generator) 503, a filter 504, an optional block 505 comprising an upsampler with an interpolation filter IPF and a multiplier 506. The output of the LFSR generator 503 is connected to the filter 504. The output of the filter 504 is processed through the block 505. The output of the interpolation filter of the block 505 is connected to a first input of the multiplier 506 and a weight factor FdevA djNoiGen is connected to a second input of the multiplier 506. The output signal of the multiplier 506 provides the (frequency) noise signal 508 to the FM path 301.

The LFSRs are used to generate a random binary sequence b [n] from the binary set {0,1,}. The input bit of the LFSR is a linear function of its previous state. An exemplary linear function is the exclusive OR (XOR) operation. The binary sequence b [n] is then mapped to a bipolar sequence x[n] with

x[n]=2·b[n]−1.

This mapping converts the sequence b [n] in the range {0,1} to x[n] in the range {−1,1}.

The mapped sequence x[n] is then passed through the filter 504 with an impulse response h(t) or a z-domain transfer function H(z) to shape the spectral properties of the sequence to generate a random frequency signal suitable for modulation.

If the impulse response of the filter is h[n], the output signal y[n] can be described in the time domain by the convolution of x[n] and h[n]:

y[n]=x[n]*h[n].

In the z-domain, the transfer function H(z) of the filter is applied to the z-transform of the input sequence X(z) as follows:

Y(z)=H(z)·X(z).

Here, X(z) is the z-transform of the input sequence x[n] and Y(z) is the z-transform of the output signal y[n].

In an example, Y(z) could be up-sampled and interpolated through the frequency noise signal 508 to increase the resolution and match the sampling rate of the PLL.

The output signal of block 505 is scaled by a weight factor FdevA djNoiGen to adjust the frequency deviation of the frequency noise signal.

In this example embodiment of FIG. 2, the frequency noise signal 508 is generated by the NG 502 using the LFSR generator 503 and is not based on the data 211. This allows configuring a spectral shape of the frequency noise signal 508 utilizing a higher degree of freedom. Also, the LFSR generator 503 can be operated at a lower sampling rate and it can be interpolated to a higher clock.

### Example: Noise Generator Without LFSR Generator

As an alternative, the noise generator 502 may be realized without any LFSR generator. Instead, the data 211 may be directly input to the filter 504.

In other words, the noise generators described herein may produce noise based on the data or such data may not have to be supplied, but instead a generator (e.g., said LFSR generator) is used to generate noise.

Example: Noise Generator as Part of the FM Path 301

The noise generator 502 may be omitted and instead the filter 303 and the pre-emphasis filter 304 can be used to generate noise directly via the FM path 301. In this case, the FM path 301 does not require the adder 306.

The filter 303 may be a Gaussian frequency shift keying (GFSK) filter. The output of the multiplier 305 is connected to the block 307 and the output of the block 307 is connected to the SDM 308 as shown in the FM path 301.

Hence, the IQ path 101 is used to generate the BT-CS packet, the FM path 301 receives the same data 211 as the IQ path 101, which the FM path filters through the GFSK filter 303 and the pre-emphasis filter 304. The SNR can be controlled through the FdevA dj signal 310 that scales the data 211 accordingly. The output of the combiner 305 is interpolated by the block 307 to a required data rate and the SDM 308 generates the FCW 311 which is used as an input sequence for the MMD 206 in the PLL 201. Advantageously, the local oscillator signal is created with a pseudo-random phase trajectory. The standard deviation of this phase can be controlled by the FdevA dj signal 310, which may in particular be a constant signal. The FdevA dj signal 310 may correspond to a gain factor to control the frequency deviation of the noise and thus impacts the SNR of the output signal 212.

In this example the FM path 301 and the PLL 201 generate the local oscillator signal flo that is used to up-convert the baseband signal that is processed via the IQ path 101. In this embodiment, the IQ path 101 generates a baseband centered at an intermediate frequency fir and the local oscillator signal (frequency) amounts to

f_{LO}=f_{ch±}f_{IF},

wherein f_{ch} indicates the frequency of the respective channel. The respective local oscillator signal (plus or minus) depends on the sideband selection. The SNR or the transmit signal can be controlled by generating the local oscillator signal with an adjustable random phase. Feeding the data 211 to the input of the IQ path 101 as well as to the input of the FM path 301 results in a phase trajectory that is correlated to the phase of the IQ path 101.

### Example: Filters in the FM Path 301

The filter 303 in the FM path 301 can be, e.g., a GFSK filter or a finite impulse response (FIR) filter. The coefficients of such filter can be configured in several ways.

This approach bears the advantage that a sequence can be obtained that is not correlated with the input signal (i.e., the data 211). The SNR of the local oscillator can be controlled via the FdevA dj signal 310 that scales the frequency deviation of the modulation signal that is provided to the MMD 206 of the PLL 201. The coefficients of the GFSK filter can be replaced by random, pseudo-random or deterministic coefficients, which may be pre-computed and loaded on demand into the filter. Also, the coefficients may be pre-calculated according to a predefined or required cost-function, which results in an output sequence of the filter that experiences less correlation in view of the actual transmit signal which further improves the accurate adjustment of the transmit signal SNR.

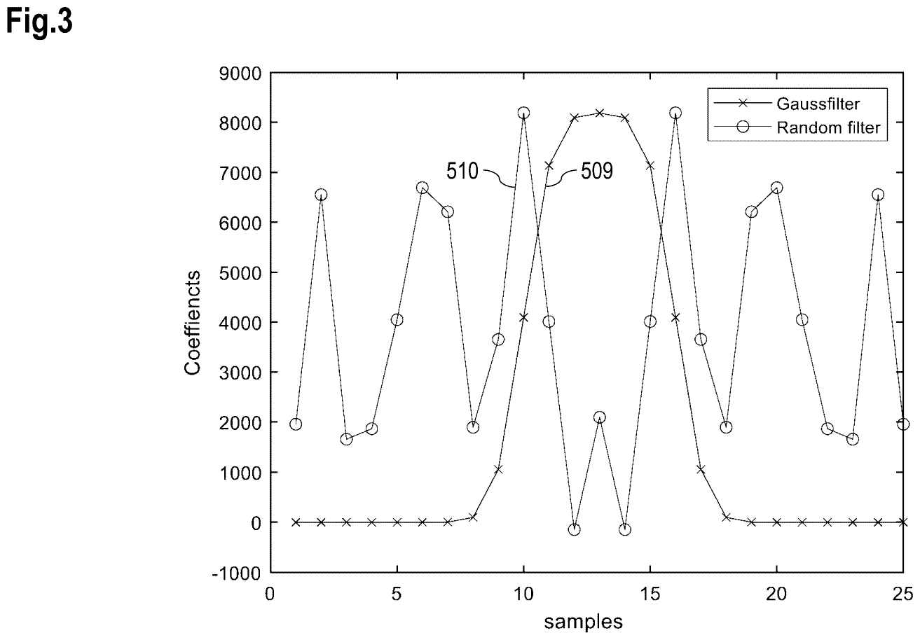

FIG. 3 shows a diagram visualizing a curve 509 of coefficients of a GFSK filter and a curve 510 of coefficients of a (e.g., pre-defined) FIR filter.

### Example: Two-Point Modulation With Slow Path and Fast Path

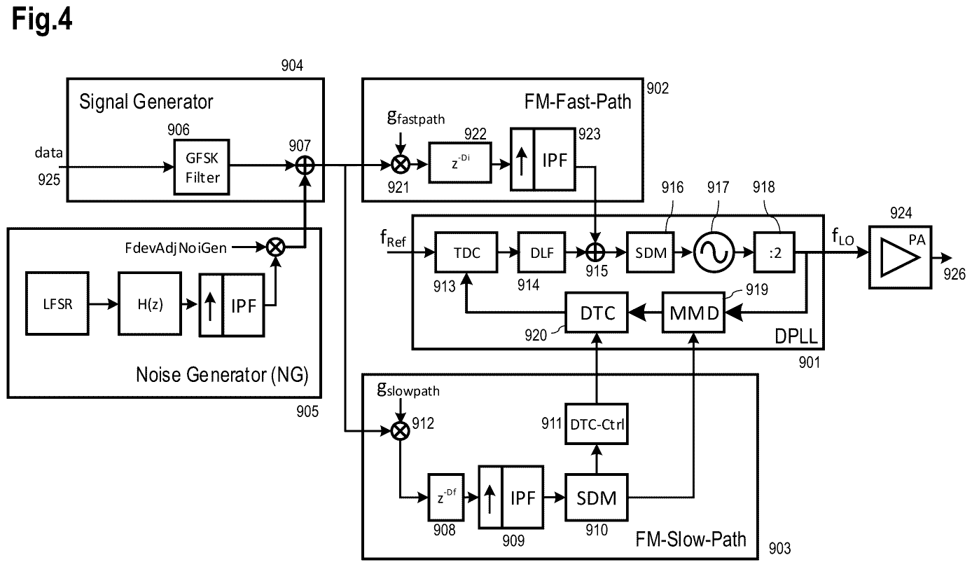

FIG. 4 shows a schematic block diagram of a digital PLL (DPLL) 901 with a two-point modulation, which can be used in frequency modulation (FM) systems. In the example of FIG. 4, the modulation signal is applied via two different paths
a fast-path via a block 902 (FM-Fast-Path) which provides an input to the DPLL 901 to control the digitally controlled oscillator (DCO) 917 of the DPLL 901; and
a slow-path via a block 903 (FM-Slow-Path) to control an MMD 919 of the DPLL 901.

A (FM) signal generator 904 comprises a GFSK filter 906 that filters (input) data 925. In the example of FIG. 4, the GFSK filter 906 is an exemplary embodiment of a pulse shaping filter to generate the required frequency modulation signal.

This frequency modulation signal is combined by an adder 907 with a noise signal from a noise generator 905. The noise generator 905 may correspond to the noise generator 502. The output of the adder 907 is conveyed to the FM-Fast-Path 902 and to the FM-Slow-Path 903.

The FM-Slow-Path 903, via a multiplier 912, scales the frequency modulation signal by a constant g_{slowpath} and subsequently processes the scaled signal through a delay block 908 introducing a delay z^{-D}^{_{f}}. Subsequently, in a block 909, the signal is up-sampled and interpolated. Next, the interpolated signal is conveyed to a sigma-delta modulator 910. The output of the sigma-delta modulator 910 controls the MMD 919 of the DPLL 901. Also, the output of the sigma-delta modulator 910 is fed to a control unit 911 for a digital-to-time converter (DTC), which is connected to a DTC 920 of the DPLL 901.

The FM-Fast-Path 902, via a multiplier 921, scales the frequency modulation signal by a constant g_{fastpath} and subsequently processes the scaled signal through a delay block 922 introducing a delay z^{-D}^{ᵢ}. Subsequently, in a block 923, the signal is up-sampled and interpolated. The output of the block 923 is fed to an input of an adder 915 of the DPLL 901.

The DPLL 901 obtains a reference signal f_{REF} which is conveyed to a time-to-digital converter (TDC) 913. The TDC 913 is connected to a digital-loop filter (DLF) 914. The output of the DLF 914 is connected to another input of the adder 915. The output of the adder 915 is connected to a sigma-delta modulator 916, which is further connected to the DCO 917. The output of the DCO 917 is connected to a frequency divider 918 and the output of the frequency divider 918 is conveyed to a power amplifier 924 as well as to the MMD 919. The output of the MMD 919 is connected to the DTC 920 and the output of the DTC 920 is connected to another input of the TDC 913. The feedback loop of the DPLL 901 comprises the MMD 919 and the DTC 920. The power amplifier 924 provides an output signal 926.

A composite signal which can be regarded as an oscillator tuning word (OTW) is applied to the DCO 917. The fractional part of the OTW is fed to the SDM 916 which may control some least significant bits (LSBs) of the varactor bank of the DCO 917. The FM-Fast-Path 902 provides a fast frequency response, ensuring that frequency modulation is applied instantaneously to the DCO 917.

The NG 905 comprises an LFSR that generates a random binary sequence, which is processed through a filter with a transfer function H(z) and scaled by a gain factor FdevA djNoiGen controlling the frequency deviation of the frequency noise and thus the SNR. A noise signal is provided at the output of the NG 905 and it is added to the output of the GFSK filter 906 of the signal generator 904 via the adder 907.

It is noted that the noise generator 905 may be realized without the LFSR generator. In such scenario, the data 925 may be directly input to the filter of the noise generator 905.

### Example: Polar Modulation With Slow Path and Fast Path

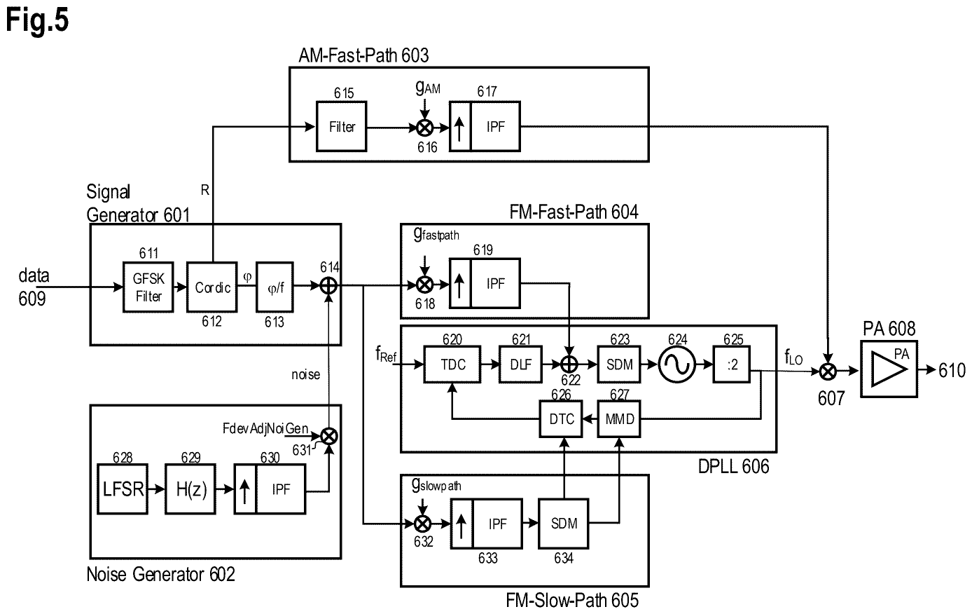

FIG. 5 shows a schematic block diagram of a polar modulation approach comprising a signal generator 601, an AM-fast-path 603, an FM-fast-path 604, an FM-slow-path 605, a DPLL 606, a noise generator 602, a multiplier 607 and a power amplifier 608.

The signal generator 601 comprises a GFSK filter 611 that filters (input) data 609. In the example of FIG. 5, the GFSK filter 611 is an exemplary embodiment of a pulse shaping filter to generate the required frequency modulation signal. The output of the GFSK filter 611 is fed to a Cordic unit 612 which generates a radius (R) component and a phase (φ) component. The R component is conveyed to the AM-fast-path 603 and the φ component is conveyed to a phase-frequency converter 613. The output of the phase-frequency converter 613 is connected to a first input of an adder 614. The output of the adder 614 is conveyed to the FM-fast-path 604 and to the FM-slow path 605.

The NG 602 comprises an LFSR generator 628 that generates a random (or pseudo random) binary sequence, which is processed through a filter 629 with a transfer function H(z) to a block 630 comprising an upsampler (indicated by an arrow) and an interpolation filter IPF. The output of the block 630 is scaled (at a multiplier 631) by a gain factor FdevA djNoiGen controlling the frequency deviation of the frequency noise and thus the SNR. The scaled output is a noise signal that is provided by the NG 602 to a second input of the adder 614.

In the AM-fast-path 603, the R component obtained from the signal generator 601 is processed by a filter 615. The output of the filter 615 is multiplied (at a multiplier 616) with a constant g_{AM} and the result of this multiplication is fed to a block 617 comprising an upsampler and an interpolation filter IPF. The output of the block 617 is conveyed to a first input of the multiplier 607.

The FM-fast-path 604 comprises a multiplier 618 for scaling the output of signal provided by the adder 614 of the signal generator 601 with a constant gfastpath. The output of the multiplier 618 is fed to a block 619 comprising an upsampler and an interpolation filter IPF. The output of the block 619 is conveyed to a first input of an adder 622.

The FM-Slow-Path 605, via a multiplier 632, scales the frequency modulation signal with a constant g_{slowpath}. Subsequently, in a block 633, the signal is up-sampled and interpolated. Next, the interpolated signal is conveyed to a sigma-delta modulator (SDM) 634. The output of the SDM 634 controls an MMD 627 of the DPLL 606. Also, the output of the SDM 634 is fed to a DTC 626 of the DPLL 606.

The DPLL 606 obtains a reference signal f_{REF} which is conveyed to a time-to-digital converter (TDC) 620. The TDC 620 is connected to a digital-loop filter (DLF) 621. The output of the DLF 621 is connected to a second input of the adder 622. The output of the adder 622 is connected to a sigma-delta modulator (SDM) 623, which is further connected to a DCO 624. The output of the DCO 624 is connected to a frequency divider 625 and the output of the frequency divider 625 is conveyed to a second input of the multiplier 607 as well as to the MMD 627. The output of the MMD 627 is connected to the DTC 626 and the output of the DTC 626 is connected to another input of the TDC 620. The feedback loop of the DPLL 606 comprises the MMD 627 and the DTC 626.

The output of the multiplier 607 is connected to the input of the PA 608 and an output signal 610 is provided as the output of the PA 608.

A composite signal which can be regarded as an oscillator tuning word (OTW) is applied to the DCO 624. The fractional part of the OTW is fed to the SDM 623 which may control some least significant bits (LSBs) of the varactor bank of the DCO 624. The FM-Fast-Path 604 provides a fast frequency response, ensuring that frequency modulation is applied instantaneously to the DCO 624.

In the AM-fast-path 603 (which can also be referred to as AM path), the component R is up-sampled to a higher rate. Then, the up-sampled signal based on the component R is fed to the multiplier 607 leading to a combination with modulated LO signal (coming from the DPLL 606).

The multiplier 607 can be realized as an RF-DAC as described in [Z. Boos et al., “A fully digital multimode polar transmitter employing 17b RF DAC in 3G mode,” 2011 IEEE International Solid-State Circuits Conference, San Francisco, CA, USA, 2011, pp. 376-378]. As an alternative, the multiplier 607 can be implemented according to [V. Kopta, R. Thirunarayanan, F. Pengg, E. Le Roux and C. Enz, “A 2.4-GHz low complexity polar transmitter using dynamic biasing for IEEE 802.15.6,” 2015 IEEE International Symposium on Circuits and Systems (ISCAS), Lisbon, Portugal, 2015, pp. 1686-1689].

It is noted that the noise generator 602 may be realized without the LFSR generator 628. Instead, the data 609 may be directly input to the filter 629 of the noise generator 602.

### Direct Frequency Modulation

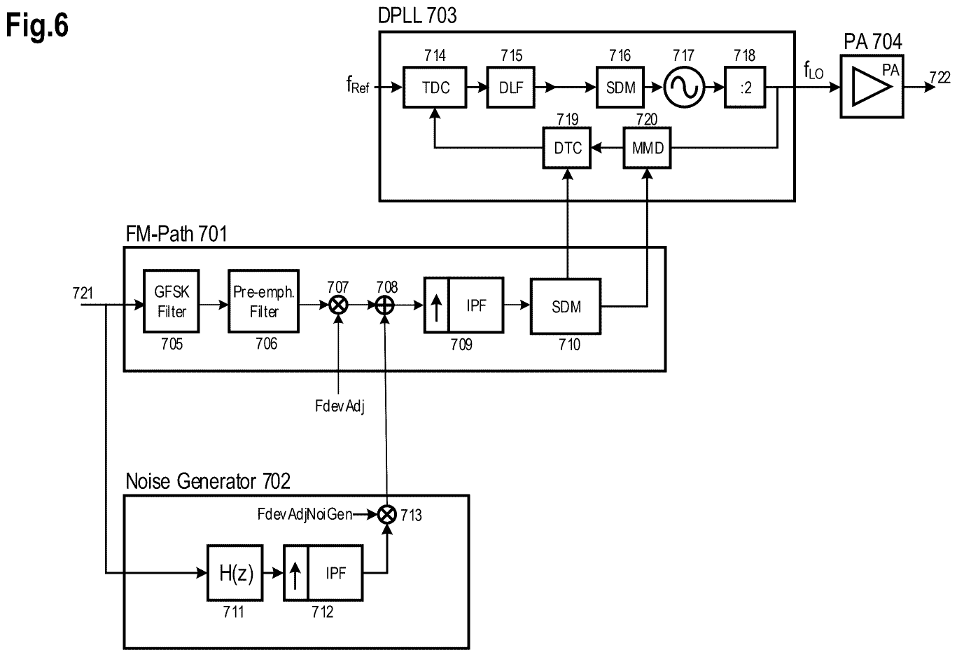

FIG. 6 shows a direct FM modulation utilizing an FM path 701, a DPLL 703, a noise generator 702 and a power amplifier 704 that supplies an output signal 722.

The FM path 701 comprises a GFSK filter 705, a pre-emphasis filter 706, a multiplier 707, an adder 708, a block 709 comprising an upconverter with an interpolation filter (IPF) and a sigma-delta modulator (SDM) 710.

Data 721 are fed via the GFSK filter 705 and the pre-emphasis filter 706 to the multiplier 707 where the signal is weighted by a gain (referred to as FdevA dj) that is used to adjust the frequency deviation of the signal. The output of the multiplier 707 is connected to a first input of the adder 708 and a second input of the adder 708 obtains noise from the noise generator 702. The output of the adder 708 is connected to the block 709 which is further connected to the SDM 710. The SDM 710 supplies an FCW to a MMD 720 of the DPLL 703 and controls a DTC 719 of the DPLL 703.

The noise can be provided by noise generators of different implementation. The example noise generator 702 comprises a filter 711 and a block 712, which comprises an upconverter and an interpolation filter. Also, the noise generator 702 comprises a multiplier 713. The data 721 is also conveyed to the filter 711 and the output of the filter 711 is connected to the block 712. The output of the block 712 is further connected to a first input of the multiplier 713. A second input of the multiplier 713 is connected to a signal FdevA djNoiGen, which scales the output of the block 712 to adjust the frequency deviation of the frequency noise signal. The output of the multiplier 713 is connected to the second input of the adder 708.

The noise provided by the noise generator 702 is added to the FM path 701 which leads to a broadening of the respective constellation points along the circle of the constellation diagram, i.e., the range of the appearance of the constellation points is widened.

The DPLL 703 obtains a reference signal fREF which is conveyed to a time-to-digital converter (TDC) 714. The TDC 714 is connected to a digital-loop filter (DLF) 715. The output of the DLF 715 is connected to a sigma-delta modulator (SDM) 716, which is further connected to a DCO 717. The output of the DCO 717 is connected to a frequency divider 718 and the output of the frequency divider 718 is conveyed to the input of the PA 704, which provides the output signal 722. The output of the frequency divider 718 is also fed to the MMD 720. The output of the MMD 720 is connected to the DTC 719 and the output of the DTC 719 is connected to another input of the TDC 714. The feedback loop of the DPLL 703 comprises the MMD 720 and the DTC 719.

Hence, the direct modulator shown in FIG. 6 allows data 721 to be processed and further conveyed via the output signal 722. The noise provided by the noise generator 702 allows adjusting the SNR of the output signal 722.

The noise generator 702 can also be implemented without any connection to the data 721. In such case, the noise generator 702 may comprise a generator like the LFSR generator described with regard to, e.g., FIG. 2, 4, or 5. On the other hand, as also indicated above, the noise generator 702 can be used instead of the noise generators 502, 905 or 602 as shown in FIG. 2, 4, or 5.

### Further Examples and Embodiments

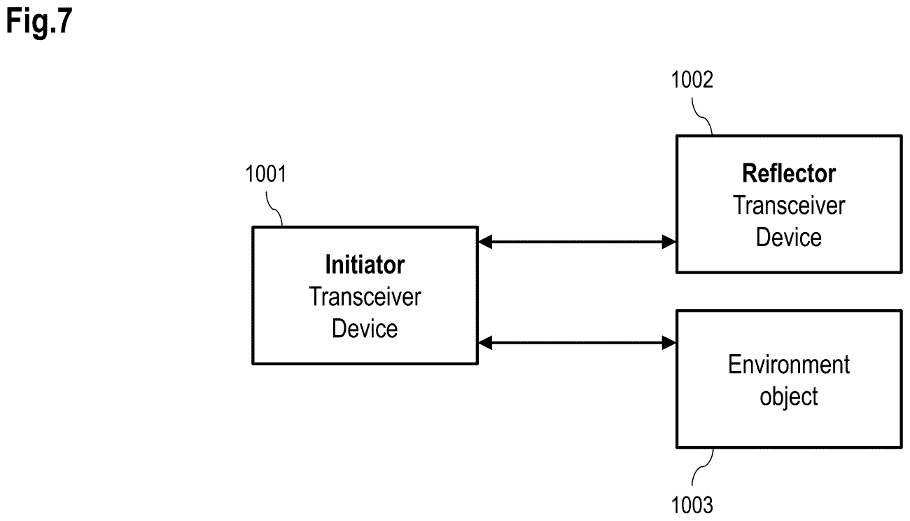

FIG. 7 shows an example block diagram visualizing different use cases for a system implementation. An initiator 1001 conveys a wireless signal to a reflector 1002 and/or to an object of the environment 1003. The initiator 1001 as well as the reflector can be realized as transceiver devices. The reflector 1002 as well as the object of the environment 1003 may reflect a portion of the wireless signal to the initiator 1001.

Examples described herein can be applied to range measurements between two transceivers, in this example between the initiator 1001 and the reflector 1002, also referred to as transceiver-to-transceiver ranging. As an alternative (or in addition), range measurement can be applied between the initiator 1001 and the object of the environment 1003, also referred to as transceiver-to-object ranging.

Transceiver-to-transceiver ranging can be conducted, e.g., for localization, for navigation and/or for secure access purposes. The initiator 1001 initiates the range measurement, the reflector 1002 response to this initiation. Example use cases for Transceiver-to-transceiver ranging may include, without limitation:
A smartphone is used as the initiator to locate a wireless headphone (e.g., earbud) or another wireless item (e.g., a tracking device attached to a key ring). In this example, the wireless headphone and the wireless item are transceiver devices used as reflectors.
A smartphone or another wireless device is used to unlock a door, e.g., a car door or a smart lock. The smartphone/wireless device may be the initiator and the car door/smart lock may be used as reflectors.
A beacon tracks a smartphone or a smart watch, e.g., during indoor movement of a user. This example can be used, e.g., for indoor sport or indoor navigation. The smartphone/smart watch can act as either initiator or reflector. Hence the beacon assumes the respective other role, i.e., reflector or initiator.
A smartphone or a smart watch are used for secure payment. The smartphone/smart watch can act as either initiator or reflector. Hence the other side, here payment device, assumes the respective other role, i.e., reflector or initiator.

Transceiver-to-object ranging solutions may also comprise radar applications that conduct range measurement and/or object detection. Examples of transceiver-to-object ranging solutions may include, without limitation:
A computer logs off when a user moves away from the computer. Here, the object is the user, which is (no longer) detected by the computer. Accordingly, a login procedure may be started when a user is detected in front of the computer.
A beacon determines and/or tracks the presence of a person and conducts a predefined action, e.g., switching lights on/off, switching air conditioning on/off, adjusting illumination level, adjusting air conditioning.
A radar device can be used to detect objects that are not visible to the human eye. For example, objects that are underground or behind barriers can be detected by radar signals.

The wireless signal addressed herein may comprise at least one of the following: a Wireless Fidelity (WiFi) signal, a Bluetooth (BT) signal, an Ultrawideband (UWB) signal.

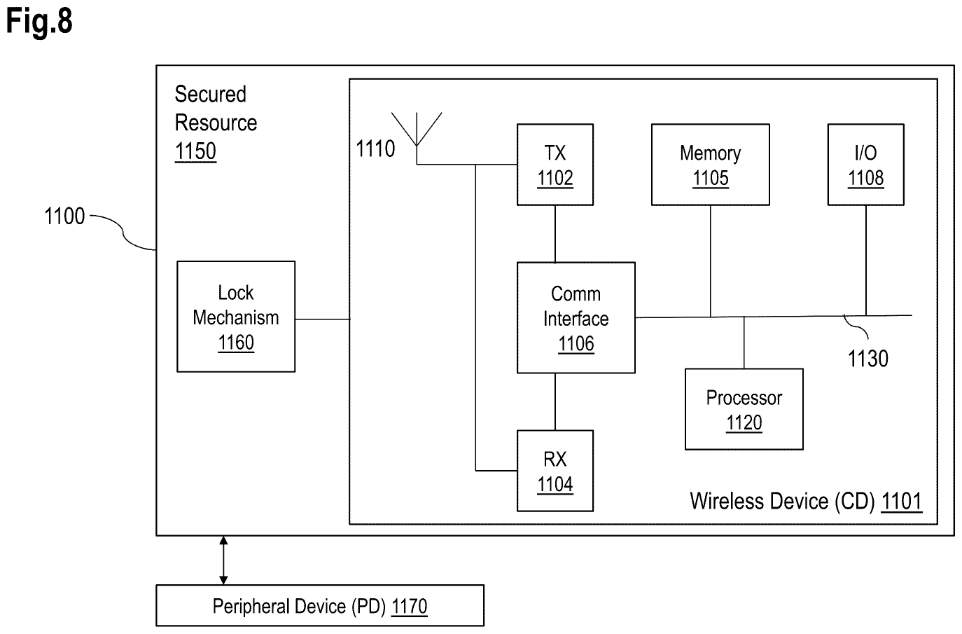

FIG. 8 illustrates a block diagram of a system 1100 useable for range measurement. In this embodiment, a wireless device 1101 acts as a central device (CD) of the wireless network and may be referred to herein as a receiving device. Further, a wireless device 1170 acts as a peripheral device (PD) of the wireless network and may be referred to herein as a transmission device. The system 1100 may include a secured resource 1150, e.g., that is secured using a lock mechanism 1160, where the peripheral wireless device 1170 is adapted to gain access to the secured resource 1150 via the lock mechanism 1160. The secured resource 1150 may be, for example, an enclosure such as a vehicle, a building, a residence, a garage, a shed, a vault, or the like. The secured resource 1150 may also be a computer system, industrial equipment, or other items requiring secured access via the lock mechanism 1160, which can be, for example, a digital locking mechanism. In some embodiments, the lock mechanism 1160 may be integrated together with the central wireless device 1101.

In some embodiments, the peripheral wireless device 1170 is any one of multiple peripheral wireless devices, as the central wireless device 1101 may be adapted to communicate with any or all of such peripheral wireless devices. In some embodiments, the peripheral wireless device 1170 is a mobile device such as a mobile phone, a smart phone, a smart watch, a pager, an electronic transceiver, a tablet, a keyless entry device, or the like. In these embodiments, the peripheral wireless device 1170 may be adapted to gain access to the secured resource 1150 by transmitting data including a frame synchronization pattern (e.g., BLE channel sounding (BLECS) synchronization pattern) encapsulated in a frame synchronization packet. The peripheral wireless device 1170 may further comprise the same or similar components as the central wireless device 1101, the descriptions of which are not repeated for brevity.

In some embodiments, the central wireless device 1101 includes, but is not be limited to, a transmitter or TX 1102 (e.g., a PAN transmitter), a receiver or RX 1104 (e.g., a PAN receiver), a communications interface 1106, one or more antennas 1110, a memory 1105, one or more input/output (I/O) devices 1108 (such as a display screen, a touch screen, a keypad, and the like), and a processor 1120. These components may all be coupled to a communications bus 1130.

In some embodiments, a separate antenna can be employed for each of the transmitter 1102 and/or receiver 1104, and so the antenna 1110 is illustrated for simplicity. In some embodiments, the memory 1105 may include storage to store instructions executable by the processor 1120 and/or data generated by the communications interface 1106. In some embodiments, front-end components such as the transmitter 1102, the receiver 1104, the communications interface 1106, and the one or more antennas 1110 described herein may be adapted with or configured for PAN-based frequency bands, e.g., Bluetooth® (BT), BLE, Wi-Fi®, Zigbee®, Z-wave™, and the like.

In some embodiments, the communications interface 1106 is integrated with the transmitter 1102 and the receiver 1104, e.g., as a front-end of the wireless device 1101. The communications interface 1106 may coordinate, as directed by the processor 1120, to request/receive packets from the peripheral wireless device 1170. The communications interface 1106 may process data symbols received by the receiver 1104 in a way that the processor 1120 can perform further processing as described herein.

Various embodiments of the ranging measurement described herein may include various operations. These operations may be performed and/or controlled by hardware components, digital hardware and/or firmware/programmable registers (e.g., as implemented in computer-readable medium), and/or combinations thereof. For example, the operations may be performed by a general-purpose computer or a processing system executing computer program stored in a computer-readable medium. The methods and illustrative examples described herein are not inherently related to any particular device or other apparatus. Various systems (e.g., such as a wireless device operating in a near or long field environment, pico area network, wide area network, etc.) may be used in accordance with the teachings described herein, or it may prove convenient to construct more specialized apparatus to perform the method steps.

A computer-readable medium used to implement operations of various aspects of the disclosure may be non-transitory computer-readable storage medium that may include, but is not limited to, electromagnetic storage medium, magneto-optical storage medium, read-only memory (ROM), random-access memory (RAM), erasable programmable memory (e.g., EPROM and EEPROM), flash memory, or another now-known or later-developed non-transitory type of medium that is suitable for storing configuration information.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “may include”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing. For example, certain operations may be performed, at least in part, in a reverse order, concurrently and/or in parallel with other operations.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by firmware (e.g., an FPGA) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the claimed subject matter to the precise forms disclosed. Many modifications and variations are possible in view of the above teachings. The embodiments were chosen and described in order to explain the principles of the embodiments and its practical applications, to thereby enable others skilled in the art to utilize the embodiments and various modifications as may be suited to the particular use contemplated. Accordingly, the present embodiments are to be considered as illustrative and not restrictive, and the claimed subject matter is not to be limited to the details given herein, but may be modified within the scope and equivalents of the appended claims.

### Further Example Embodiments

Examples suggested herein may be based on at least one of the following solutions. Combinations of the following features could be utilized in order to reach a desired result. The features of the method could be combined with any feature(s) of the device, apparatus or system or vice versa. The “embodiments” mentioned herein are merely examples of features that could be optionally introduced. These embodiments are no limitation of the independent claims.

A modulator is suggested comprising:
a modulation path configured to generate a modulated signal based on input data;
an up-converter configured to combine the modulated signal with a local oscillator signal into an output signal;
a PLL configured to generate the local oscillator signal based on a reference signal and a control signal;
a noise generator configured to supply a noise to a frequency-modulation path that provides the control signal for the PLL.

According to an embodiment, the modulator is configured to process the input data to be modulated via the modulation path and via the frequency modulation path.

According to an embodiment, the noise generator is configured to generate noise based on the input data.

According to an embodiment, the noise generator is configured to generate noise autonomously without considering the input data.

According to an embodiment, the modulation path comprises an IQ modulation path.

According to an embodiment, the modulation path comprises a polar modulation path.

According to an embodiment,
the polar modulation path is configured to determine an amplitude component and a phase component based on input data,
the frequency modulation path and the PLL are configured to process the phase component,
the modulator further comprising:
   an AM path configured to process the amplitude component,
   a combiner configured to process the processed amplitude component and the processed phase component.

According to an embodiment, the frequency modulation path further comprises a fast path and a slow path, wherein the slow path is configured to adjust the control signal for the PLL and the fast path is configured to provide a fast frequency response for the PLL.

According to an embodiment, the noise generator is configured to supply the noise to the fast path and to the slow path of the frequency modulation path.

According to an embodiment, the modulator is a Bluetooth modulator or a modulator applied in a Bluetooth application.

Also, a modulator is suggested comprising:
a frequency modulation path configured to generate a modulated signal based on input data;
a PLL configured to generate a modulated local oscillator signal based on a reference signal, a control signal and the modulated signal;
a noise generator configured to supply a noise to the frequency-modulation path that provides the control signal for the PLL.

According to an embodiment, the noise generator is configured to generate noise based on the input data.

According to an embodiment, the noise generator is configured to generate noise autonomously without considering the input data.

According to an embodiment, the frequency modulation path further comprises a fast path and a slow path, wherein the slow path is configured to adjust the control signal for the PLL and the fast path is configured to provide a fast frequency response for the PLL.

According to an embodiment, the noise generator is configured to supply the noise to the fast path and to the slow path of the frequency modulation path.

According to an embodiment, the modulator is a Bluetooth modulator or a modulator applied in a Bluetooth application.

Also, an apparatus is provided
comprising a Bluetooth modulator providing an output signal,
wherein the Bluetooth modulator is capable of adjusting a signal-to-noise ratio of the output signal via a noise generator,
wherein the noise generator is configured to supply noise to a frequency modulation path of the Bluetooth modulator.

According to an embodiment, the Bluetooth modulator comprises an IQ modulation path or a polar modulation path.

According to an embodiment, the Bluetooth modulator is configured such that the noise generator generates noise based on input data or autonomously without considering the input data.

According to an embodiment, the apparatus further comprises a receiver, wherein the Bluetooth modulator and the receiver are coupled to a communication interface, which is connected to a processor, wherein the processor is configured to be capable of conducting Bluetooth channel-sounding.

1. A modulator comprising:
a modulation path configured to generate a modulated signal based on input data;
an up-converter configured to combine the modulated signal with a local oscillator signal into an output signal;
a PLL configured to generate the local oscillator signal based on a reference signal and a control signal;
a noise generator configured to supply a noise to a frequency-modulation path that provides the control signal for the PLL.

2. The modulator according to claim 1 configured to process the input data to be modulated via the modulation path and via the frequency modulation path.

3. The modulator according to claim 1, wherein the noise generator is configured to generate noise based on the input data.

4. The modulator according to claim 1, wherein the noise generator is configured to generate noise autonomously without considering the input data.

5. The modulator according to claim 1, wherein the modulation path comprises an IQ modulation path.

6. The modulator according to claim 1, wherein the modulation path comprises a polar modulation path.

7. The modulator according to claim 6,
wherein the polar modulation path is configured to determine an amplitude component and a phase component based on input data,
wherein the frequency modulation path and the PLL are configured to process the phase component,
further comprising:
an AM path configured to process the amplitude component,
a combiner configured to process the processed amplitude component and the processed phase component.

8. The modulator according to claim 7, the frequency modulation path further comprising a fast path and a slow path, wherein the slow path is configured to adjust the control signal for the PLL and the fast path is configured to provide a fast frequency response for the PLL.

9. The modulator according to claim 8, wherein the noise generator is configured to supply the noise to the fast path and to the slow path of the frequency modulation path.

10. The modulator according to claim 1, wherein the modulator is a Bluetooth modulator or a modulator applied in a Bluetooth application.

11. A modulator comprising:
a frequency modulation path configured to generate a modulated signal based on input data;
a PLL configured to generate a modulated local oscillator signal based on a reference signal, a control signal and the modulated signal;
a noise generator configured to supply a noise to the frequency-modulation path that provides the control signal for the PLL.

12. The modulator according to claim 11, wherein the noise generator is configured to generate noise based on the input data.

13. The modulator according to claim 11, wherein the noise generator is configured to generate noise autonomously without considering the input data.

14. The modulator according to claim 11, the frequency modulation path further comprising a fast path and a slow path, wherein the slow path is configured to adjust the control signal for the PLL and the fast path is configured to provide a fast frequency response for the PLL.

15. The modulator according to claim 14, wherein the noise generator is configured to supply the noise to the fast path and to the slow path of the frequency modulation path.

16. The modulator according to claim 11, wherein the modulator is a Bluetooth modulator or a modulator applied in a Bluetooth application.

17. An apparatus
comprising a Bluetooth modulator providing an output signal,
wherein the Bluetooth modulator is capable of adjusting a signal-to-noise ratio of the output signal via a noise generator,
wherein the noise generator is configured to supply noise to a frequency modulation path of the Bluetooth modulator.

18. The apparatus according to claim 17, wherein the Bluetooth modulator comprises an IQ modulation path or a polar modulation path.

19. The apparatus according to claim 17, wherein the Bluetooth modulator is configured such that the noise generator generates noise based on input data or autonomously without considering the input data.

20. The apparatus according to claim 17, further comprising a receiver, wherein the Bluetooth modulator and the receiver are coupled to a communication interface, which is connected to a processor, wherein the processor is configured to be capable of conducting Bluetooth channel-sounding.
